(19) United States
(12) Patent Application Publication
(10) Pub. No.: US 2008/0276441 A1
(43) Pub. Date: Nov. 13, 2008

(54) Tubular assembly and method

(76) Inventors: Edwin G. Estochen, Aiken, SC (US); James E. Klein, Evans, GA (US)

Correspondence Address: MCNAIR LAW FIRM, P.A., P.O. BOX 10827, GREENVILLE, SC, 29603-0827, US

(21) Appl. No.: 12/218,455

(22) Filed: Jul. 15, 2008

Related U.S. Application Data
(62) Division of application No. 11/243,545, filed on Oct. 5, 2005.

(51) Int. Cl. B23P 11/00

(52) U.S. Cl. 29/428

(57) ABSTRACT

A tubular assembly and method for its manufacture is disclosed wherein an internal device is positioned and sealed in-line within a metal tube that is formed by two sections which are spin, inertia, or forge welded together so that the flash produced by the weld flows into the interior tube where the device is placed and the flash seals the device outer wall peripherally to the tube inner wall to form a gas tight seal. In a preferred embodiment the internal device is a gas filter for hydrogen gas.

### CROSS REFERENCE TO RELATED APPLICATION

This application is a division of application Ser. No. 11/243,545, filed Oct. 5, 2005.

### STATEMENT OF GOVERNMENT RIGHTS

The United States Government has rights in this invention pursuant to Contract No. DE-AC09-96SR18500 between the U.S. Department of Energy and Westinghouse Savannah River Company, LLC.

### FIELD OF THE INVENTION

This invention relates to a method of positioning and sealing internal components within a metallic tube and to the products of the method. Particularly, the invention relates to an assembly comprising a filter of porous metal that has been sealed within a metal tube by the spin welding technique.

### BACKGROUND OF THE INVENTION

Positioning and sealing working devices within a metal tube or conduit is a difficult task and is quite time consuming when done accurately and repeatedly. A particular device that requires reliable positioning and sealing is the gas or fluid filter. Gas and fluid filters are found wherever the removal of particulate matter from a gas or fluid stream is important. Numerous types of filter assemblies are known and are commercially available. Fuel filters, water filters, and air filters are used in and are required by many commercial, industrial, and residential applications. Generally mechanical filters are made of a porous material which can be metal or plastic screens, fabric, porous ceramics and metals, or paper that block undesirable particles and allow only the desired gas or fluid to pass through.

Filters are generally positioned within a conduit for a gas or fluid so that the gas or fluid stream traveling through the conduit must pass through the filter. In many applications the integrity of the seal of the filter to the walls of a conduit or passageway is not critical as it is satisfactory for a relatively high percentage of particles to be removed. However, in applications where gas purity is critical because the downstream use of the gas or fluid requires a high degree of purity in order to avoid damage to sensitive equipment, the integrity of the seal of the filter to the conduit walls is quite important.

One particularly sensitive filtering operation is that of filtering hydrogen gas. For instance, in a filter/tube assembly that serves as a hydrogen reactor where hydrogen gas is supplied from one end of the tube, passes through the filter, and reacts with a hydride that absorbs hydrogen, the hydride material is initially in pellet form, but over a series of hydrogen absorption and desorption cycles (desorption is defined as the process by which hydrogen is driven off of the hydride via application of heat, and processed through the exhaust end of the filter/tube assembly), the pellets break down into very small particles which will damage the supply system if they were to pass to the supply or opposite side of the filter. To keep the hydride particles on the exhaust side of the filter, it is necessary to devise a way to seal the filter inside the tube without damaging or clogging the porous metal filter. Brazing or conventional welding does not work well due to loss of filter efficiency caused by the flow of molten metal around the perimeter of the filter in the gap between the filter and the tube inner wall. Initial attempts at mechanical methods of fixing/sealing the filter consisted of using a blunt pipe cutter to compress the tubing against the filter. This technique was unsuccessful because ovalization rather than concentric or circular reduction of the tube inside diameter resulted in a gap that creates a path for the hydride particles to pass to the supply side of the filter. Additionally, pressurization of the tube resulted in expansion of the tube away from the filter. Another option is to shrink fit the filter into the tube. Shrink fitting of the tube/filter would be achieved by using a filter with an outside diameter slightly larger than the inside diameter of the tube, heating the tube to make the inside diameter larger, cooling the filter to make its outside diameter smaller, placing the filter inside the tube, and then allowing the two pieces to reach a uniform temperature. After reaching thermal equilibrium, the filter would be fixed in place and sealed as the parts returned to their original dimensions, resulting in compression of the expanding filter by the contracting tube. This method also results in some loss of filter efficiency since gas flow through the perimeter surface area of the filter would be blocked by contact with the tubing. Again, pressurization of the tube would be limited in order to prevent expansion of the tube from causing loss of contact with the filter. For small parts similar to those used for a hydrogen reactor, shrink fitting was not practical since temperature differences between the two parts of approximately 700° F. degrees would have been required. Accordingly, a general object of the present invention is to overcome the aforementioned problems in maintaining an effective seal between the filter and the tube wall in the presence of high internal pressure.

A method of joining plastic parts together to form a fluid filter assembly is disclosed in U.S. Pat. No. 6,896,753 B2 to Memmer wherein a filter is placed within aligned housing shells and the plastic flash from welding the joint between the housing walls together is used to peripherally seal the filter to the housing inner walls. However, the Memmer filter assembly is formed from plastic materials and employs a housing with upper and lower end walls to prevent the filter from moving upstream or downstream while the welding operation takes place. Accordingly, another object of the present invention is to position and seal a filter in line in a tube or conduit without the necessity of employing a filter housing. A further object of the present invention is to form a gas filter of porous metal in a metal tube by the spin welding process.

These and other objects are realized by the present invention which is summarized below.

### SUMMARY OF THE INVENTION

It has been surprisingly discovered that internal devices in a metallic tubular conduit may be sealingly positioned and held in place by plasma or plastic flow flash from the joining of tubular conduit sections adjacent said devices and which section have a constant diameter adjacent said device. In one aspect, the present invention is a gas filter assembly comprising a metallic tube, a cylindrically-shaped filter positioned within said tube where the filter has a smaller outer diameter than the inner diameter of the tube and metal flash is formed around the periphery of the filter so that the flash closes and seals the space between outer wall of the filter and the inner wall of the tube thereby holding the filter in a fixed, sealed position. In another aspect, the filter is a porous metal or a porous ceramic or cermet material. In a further particularly useful aspect of the present invention, the tube on one side of said filter is filled with a metal hydride so that gas evolving therefrom passes through and is filtered by the filter. Internal devices that may be positioned within tubes or conduits according to the invention include filters, valves, metering or measuring instruments and the like.

In yet another aspect, the present invention is a method of making a filter assembly by positioning and securing a filter within a metallic tube and forming a gas or liquid tight seal between the filter and the interior wall of the tube comprising the steps of: providing a stationary metallic tube section having an open end; positioning a cylindrically-shaped fuel filter within said open end so that the filter and tube are coaxially aligned, said filter having an outer diameter smaller than the inner diameter of the tube; holding said filter in said aligned position with a centering fixture; positioning a rotatable metallic tube section having an open end over said fixture and filter, said rotatable tube having the same inner diameter as the stationary tube; abutting the open ends of the stationary and rotatable tube sections so that said sections are coaxially aligned and said abutting ends are adjacent said filter; pressing the abutting ends of said aligned tube sections together and rotating the rotatable tube while gripping the stationary tube section to prevent its rotation; and continuing the rotation of the rotatable tube section until the friction between the pressed together abutting tube sections causes material from said tubes to flow as flash inwardly into the interior of said sections to contact the wall of said filter around the periphery of the filter; terminating the rotation of said rotatable tube section whereby upon cooling, said tube section ends become joined to form a single continuous tube and the flash seals the outer surface of the filter to the inner wall of the continuous tube around the periphery of the filter thereby securing and sealing the filter within the tube. It is preferable that the rotatable and stationary tube sections should be formed from the same metal. However, in the foregoing process dissimilar metals may be joined and in some instances, metals may be joined to non-metals. Some specific metals and combinations thereof which may be joined are steel alloys, aluminum alloys, magnesium alloys, and copper alloys and the non-alloyed forms of these metals. This listing is exemplary and not exhaustive. In one still further aspect the centering fixture may be a resilient, annular washer or sleeve that holds the filter in place and that may be removable.

In still yet another aspect of the present invention, the tube sections have essentially the same outer and inner diameters. While it is not essential that the outer diameters are the same it is preferred that the inner diameters are.

In addition, the method of the present invention includes a filter which permits hydrogen gas to flow therethrough and further includes the step of filling at least a portion of one of the tube sections with a metal hydride from which hydrogen gas will evolve and pass through the filter.

The foregoing described invention will be better understood by reference to the drawings and detailed description which follows.

### BRIEF DESCRIPTION OF THE DRAWINGS

A preferred construction designed to carry out the invention will hereinafter be described in detail with reference to the schematic representations provided in the drawings.

Accordingly, attached hereto and made a part of this disclosure are drawings which are presented by way of illustration and not limitation. In the drawings:

FIG. 1 is a schematic representation of two metal tube sections before being joined with a filter positioned in the stationary tube section;

FIG. 2 is a schematic representation of the two tube sections after having been joined by a spin welding process; and,

FIG. 3 is a sectional view of the joined tube of FIG. 2 showing a filter in place inside the tube and including metallic hydride pellets inside the tube.

### DETAILED DESCRIPTION

In the art, terms such as “friction welding”, “spin welding” and “inertial welding” can be found. These welding processes can generally be referred to as “solid state welding.” Usually frictional welding is carried out by moving one component relative to another on a common interface while applying a compressive force across the interface that forms the joint. The friction heat generated at the interface softens both components and when they become plasticized the interface material is extruded out of the edges of the joint so that clean material from each component is left along the original interface. The relative motion is then stopped and a higher final compression force may be applied before the joint is allowed to cool. A feature of friction welding is that no truly molten state material is generated as the weld is formed in the solid state. The material which is extruded out of the edges of the joint is called flash.

Spin welding is a process in which one component is rotated relative to each other and against each other and is probably the most commonly used of the friction welding processes. Many carbon steel vehicle axles and sub axles are assembled using this technique. The process is also used to fabricate connecting rods, steering columns, and drive shafts as well as engine valves in which the ability to join dissimilar materials means that, for example, a valve stem and a valve head can be made of different metals suited to the specific requirements for each part.

Spin welding is also used to join thermoplastic parts. During spin welding one part is held stationary in a holding fixture while a second part is rotated against it under pressure at speeds from 2400 to 20,000 rpm. The resulting friction causes the metal in the joining surfaces to flow and fuse together producing a strong welded joint. U.S. Pat. No. 5,049,274 to Leason, et al. describes a friction welding process of using plastic parts and a filter formed by the process. An example of non-metallic parts being welded to metals is described in U.S. Pat. No. 5,735,446 to White, et al. The teachings of these patents are incorporated herein by reference.

In more specific detail regarding the present invention it is desirable to use one of the “flash” producing variations of solid-state welding. These processes are those that produce coalescence of the faying surfaces at temperatures that are typically 50-70% of the melting point of the materials being joined, without the addition of filler metal. This temperature is high enough to cause plasma or plastic flow under the continued application of force between the two parts, but is not high enough to cause melting as with conventional welding techniques. For a given force, the amount of flash producing upset, or plastic flow, that occurs during the weld is a function of time (i.e., the longer the duration application of force, the greater amount of material that is expelled at the interface location). For two solid parts joined this way, the flash on the finished part is seen as a mushroom of material on the outside surface. For two hollow parts, the upset exists both inside and outside the parts in basically equal proportions. While the flash is usually considered waste, and machined from finished parts, it serves an important function for the present invention as it comes in contact with the internal part because the flash creates a seal around the perimeter of the internal piece and locks it in place via mechanical means. While material compatibility for the faying surfaces may be important to produce the highest quality weld, compatibility between the internal part and the flash material is not an issue since the seal formed between the two only relies on intimate contact and not bonding. One important requirement for this technique is that the internal piece or device has sufficient strength to resist any loads imposed on it by the flash material during welding.

For flash producing solid state welding processes in general, pressure is applied in combination with a heat generating process to produce the deformation necessary to create high quality joints between both similar and dissimilar materials and the heat generated or applied is always less than that required to melt the materials. The applied force or pressure controls the amount of reduction in length of the part or upset and the resulting production of flash.
In one embodiment of the invention inertia-drive is employed as opposed to direct drive, friction welding. For friction welding, direct conversion of mechanical energy to thermal energy is used to form the weld. The typical friction welding machine known to those skilled in the art includes a spindle that holds and rotates one of the parts to be joined while translating it toward the other part which is held stationary. The welding sequence includes bringing the spindle/flywheel to speed, disengaging the drive system, applying constant axial pressure, and allowing the spindle to come to a stop under the friction caused by the applied pressure. The flywheel moment of inertia, along with rotational speed dictates the amount of energy used during the welding process. Parameters associated with the inertia-drive friction welding equipment include rotational speed, and axial force.

Another solid state welding process is the forge welding process. Forge welding is characterized by the application of pressure to firmly seat two faying surfaces together, heating the joint to the welding temperature, and rapidly applying additional pressure to upset the weld zone. Heating of the joint is achieved with torches, contact resistance heating due to an applied current, or induction heating or by flame but no additional metal is used. Heating is controlled so that temperatures are in the plastic flow region but remain below the melting temperature of the materials being joined. The advantage of using this technique over friction welding is that the straight push associated with forge welding permits the internal part to be placed at the desired location with minimal or no required fixturing, and eliminates the need to hold the internal part stationary during welding. For friction welding, alignment and proper clearance of the internal part is critical to prevent problems such as contact between the rotating piece and the internal part.

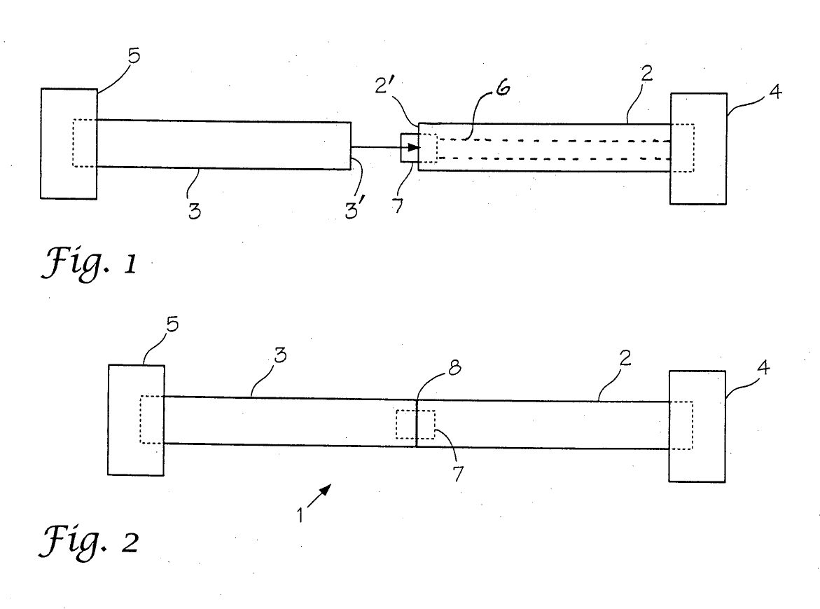

Turning now to FIG. 1, the surprising discovery of a use of the spin welding process to make a unique and novel filter assembly will be described. Stationary tube section 2 is shown held by grip 4 with centering fixture 6 holding filter 7 in place. The tube section is preferably a steel alloy. Rotatable tube section 3 is also preferably a steel alloy and is held by grip 5. In a simple arrangement the grip 4 which holds the stationary tube 2 may be held in a vice to prevent its rotation. After the tube section 3 is moved in the direction of the arrow to close the space between the two tube sections so that the open ends 2′ and 3′ abut in a coaxial aligned manner, grip 4 is rotated to spin the rotatable tube 3 at a relatively high speed. The chuck from a heavy duty high speed drill can be attached to the grip and the drill motor itself employed as the drive to spin the tube. It is understood that while the member 7 has been described as a filter, any cylindrically-shaped device or component may be positioned and sealed within a tube by the present method. For example, a one-way flow valve could be so positioned and sealed to prevent back flow.

The joined together or pressed together tube sections 2 and 3 will have the appearance as shown in FIG. 2 while they are spinning and the flash will be developed in the weld joint 8 which will move inwardly to attach to the filter 7. Upon termination of the rotation the tube sections are pressed more tightly together and held and cooled. The end surfaces of each section are now joined firmly so that a continuous tube 1 with the filter 7 enclosed therein is formed. The centering fixture can be removed at this point out the end of the tube. As an alternate to a centering fixture, a thin washer of a resilient material can be used to hold the filter in place. The washer can be a short sleeve of a thin elastomeric material. The sleeve may remain in the tube with the seal formed by the flash being the hermetic seal to prevent gas flow around the filter. If the sleeve remains it is desirable that it be formed of a porous material so that it does not unduly block the side surface pores of the filter. Furthermore, in the forge welding process the tube sections 2 and 3 need to be heated and pressed together but do not need to be rotated relative to each other.

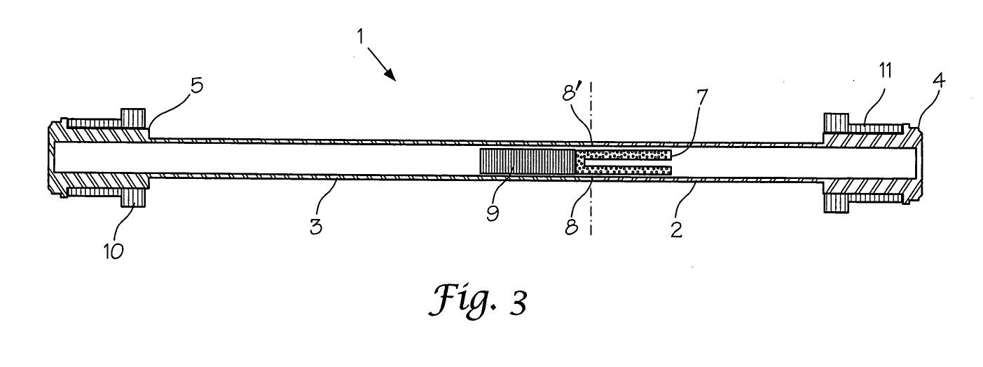

Looking now at FIG. 3 which is a sectional view of a preferred embodiment and best mode of the present invention, holding nuts 10 and 11 are shown which aid in performing the functions of grips 4 and 5 from FIGS. 1 and 2. Flash 8′ which has been extruded out from the weld area 8 from each tube is shown holding the filter 7 and the flash has flowed around the periphery of the filter as a continuous seal. The filter 7 can be a porous metal, a cermet that is porous, or a ceramic that is porous. In this embodiment the tube sections have an outer diameter of 0.375″ with a wall thickness of 0.035″. The filter in this preferred embodiment has an outer diameter of 0.25″ and is 2.5″ long. In the rotatable tube section metal hydride pellets are loaded that are 0.24″ in overall diameter and 0.1525″ in length. Examples of metal hydride used as a hydrogen gas storage medium can be found in U.S. Pat. No. 6,432,379 B1 to Heung the disclosure of which is incorporated herein by reference.

The method of the present invention where the weld flash from an inertial or spin weld is used to fix and seal tube internal devices such as a filter provides full filter efficiency and reduces the concern about loss of contact between the filter and flash material due to pressurization of the tube. Filter efficiency is maintained because the flash created by inertial welding is not liquid but a flowing semi-solid. Since it is semi-solid, the flowing flash does not enter the filter pores, but does form a mechanical seal as it comes in contact with the filter. As the flash flows toward the center of the tube it is redirected along the side of the filter producing a more secure seal. Loss of contact between the tube and internal device due to pressurization is not completely eliminated, but is greatly reduced as a concern since the area sealed by the flash has much greater strength and resistance to deformation because of the quantity of additional material present and because the material is the metal of the tube wall.

The foregoing described method and product provide a less complicated and more direct method of attaching a porous metal filter within a tube and is quicker and more satisfactory than could be obtained with the usual heat welding process where the heat from the welding process might cause the metal within the porous filter to flow and close off a greater portion of its surface pores and internal filter channels thus reducing its effectiveness. Furthermore, the device for holding or centering the filter does not have to be insulated from the effects of heat welding.

Examples of other internal devices are solid inserts which may be metal, ceramic, glass, or any other material that can withstand the forces produced during the welding process. One use of a solid insert may be as a pressure relief device where failure of the insert would permit material to flow past the insert when a pre-determined pressure level is reached. Another application is to substitute the filter for a finned copper insert for heat transfer between fluid flowing through a tube or pipe. Replacing the filter with a mechanical device that rotates in response to fluid flow as a metering or flow control device is another potential application. In addition, another potential application for acoustic or optical transmission through a fluid would be to have a transparent insert where fluid is on one side, gas on the other, and light being transmitted through the length of the tube. The usefulness of the invention is that it mechanically locks the internal devices in place, and provides a seal. While both fixing and sealing filter applications, the ability to either fix or seal opens the technique to numerous other uses. Another advantage of the invention is that it is not limited to the joined materials being identical, since solid state diffusion forms the bond between the two rather than melting and material recrystallization as in conventional welding techniques.

The foregoing disclosure is provided for the purpose of explaining and disclosing a preferred embodiment of the present invention. Modifications and adaptions to the described embodiments, particularly including changes in configuration and materials may be contemplated by those skilled in the art. Such changes and others may be made without departure from the scope and spirit of this invention which is limited in scope only by the following claims:

1. A method of making a tubular assembly having an internal device positioned and secured within a metallic tube comprising the steps of:
a) providing a stationary metallic tube section having an open end;
b) positioning a cylindrically shaped device within said open end so that the device and tube are coaxially aligned, said device having an outer diameter smaller than the inner diameter of said tube;
c) holding said device in said aligned position with a centering fixture;
d) positioning a rotatable metallic tube section having an open end over said fixture and device, said rotatable tube having the same inner diameter as the stationary tube;
e) abutting the open ends of the stationary and rotatable tube sections such that said sections are coaxially aligned, and said abutting ends are adjacent said device;
f) pressing the abutting ends of said aligned tube sections together and rotating the rotatable tube while gripping the stationary tube section to prevent its rotation; and,
g) continuing the rotation of the rotatable tube section until the friction between the pressed together abutting tube section ends cause material from said tubes to flow as flash inwardly into the interior of said sections to contact the wall of said filter around the periphery of the device;
h) terminating the rotation of said rotatable tube section whereby, upon cooling, said tube section ends become joined to form a single continuous tube and the flash seals the outer wall of the device to the inner wall of the continuous tube.

2. The method of claim 1 wherein the rotatable and stationary tubes are formed from the same metal.

3. The method of claim 1 wherein the stationary and rotatable tubes are from dissimilar metals.

4. The method of claim 1 wherein the centering fixture is a resilient, annular sleeve.

5. The method of claim 1 wherein said device is a filter for hydrogen gas as it evolves from a hydride material.

6. The method of claim 1 wherein the metallic material for said sections is selected from the group consisting of steel alloys and aluminum alloys.

7. The method of claim 1 wherein both tube sections have essentially the same outer and inner diameters.

8. The method of claim 5 wherein the filter permits hydrogen gas to flow therethrough and including the additional step of filling at least a portion of one of the tube sections with a metal hydride.

9. The method of claim 1 including after step e) and before step f) the step of heating the abutting ends to a temperature approaching but below the melting point of the material of either tubular section.

10. A tubular assembly made according to the process of claim 1.

11-17. (canceled)

18. A method of making a tubular assembly having internal devices or components positioned and secured within a metallic-tube comprising the steps of:
a) providing two metallic tube sections having open ends that can be conformingly abutted;
b) positioning a device within and adjacent the open end of one tube;
c) pressing said tube ends together and heating said tube ends to the plastic flow temperatures of the tube materials but below the melting temperature of the materials; and
d) further pressing said tube sections together wherein flash is extruded that flows to and secures said device.

19. The method of claim 18 where the heating of the tube ends is carried out by rotating said tube relative to each other.

20. The method of claim 18 wherein the heating of the tube ends is carried out by a process selected from electrical resistance heating, indication heating or heating by flame.
